(19) United States
(12) Patent Application Publication
(10) Pub. No.: US 2023/0075164 A1
(43) Pub. Date: Mar. 9, 2023

(54) MEDIA DEVICE FOR FACE COVERINGS

(71) Applicant: Beau Blessing, Dade City, FL (US)

(72) Inventor: Beau Blessing, Dade City, FL (US)

(21) Appl. No.: 17/466,397

(22) Filed: Sep. 3, 2021

(51) Int. Cl. G10L 21/10; G10L 15/00; G10L 25/78; H04R 9/08

(52) U.S. Cl. CPC G10L 21/10; G10L 15/00; G10L 25/78; H04R 9/08

(57) ABSTRACT

A microphone 12 joined by a support means 16 to a case 14 which communicates speech into light displayed through a transparent case top 10. The support mean is made of a sufficiently flexible material so it functions as a clasp repeatedly without fracturing. The support means 16 can be molded construction or pieces 20, 22, 32 joined with adhesive, pressure, heat, fasteners or other means. The case top 10 is made of a transparent material. In addition, the case may receive case tops via tabs 48 and tab holes 50, adhesive or fasteners such through holes 44 and onto supports 46.

### CROSS-REFERENCE TO RELATED APPLICATIONS

This application is entitled to the benefit of Provisional Patent Application Ser. #63/073,454, filed Sep. 2, 2020.

### BACKGROUND

This invention relates to speech detection for media display, specifically such a display positioned about the face for attachment to facial coverings.

Fabric facial coverings are commonly worn in medical settings as well as public spaces to promote health. Such coverings are used to mask the wearer's nose and mouth. However, communication thrives on elements of visual and audible signals. Thus these facial masks obscure facial expression while also impeding audible speech.

### SUMMARY

In accordance with the present invention a speech augmentation device comprises an audio detection means, a means of support and a media emitting platform.

### OBJECTS AND ADVANTAGES

Accordingly, besides the objects and advantages of the media device described in my above patent, several objects and advantages of the present invention are:
(a) To provide a media device which can allow speakers to signal speech to others visually;
(b) To provide a media device which allows for a replaceable frontispiece, or case top;
(c) To provide a media device which the case top can be different shapes;
(d) To provide a media device which the case top can be different colors;
(e) To provide a media device which can be brightly colored;
(f) To provide a media platform which case top can be different translucent;
(g) To provide a media device which allows for a range of media;
(h) To provide a media device which allows for a range of light emitting sources;
(i) To provide a media device which allows for a range of sound emitting sources;
(j) To provide a media device which can be positioned about the face;
(k) To provide a media device which can be attached to fabrics without penetration;
(l) To provide a media device which allows for emitting various wavelengths of light;
(m) To provide a media device which promotes health through light media;
(n) To provide a media device which promotes health through sound media;
(o) To provide a media device which can be colored in several colors simultaneously;
(p) To provide a media device which allows for utilization of existing graphic artwork;
(q) To emit energy about the face when speech is detected.

### DRAWING FIGURES

FIGS. 1A and 1B show various aspects of a media platform and case top, unattached, supplied with a microphone and means of support.

FIGS. 2A and 2B show a media platform positioned about a material with case top applied.

FIG. 3A-3C shows various aspects of a medial platform with case top applied.

FIG. 4A to 4C shows various aspects of various case top shapes.

FIG. 5 shows one of enumerable shape iterations of a media platform.

FIG. 6A to 6C shows various means of supporting microphone to case.

FIG. 7A to 7D shows various means of applying case top to case.

Reference Numerals In Drawings

| | |
|---|---|
| 10 | case top |
| 12 | microphone |
| 14 | case |
| 16 | support means |
| 20 | attachment appendage |
| 22 | attachment groove |
| 32 | attachment point |
| 42 | support groove |
| 44 | through-hole |
| 46 | screw riser |
| 48 | tab |
| 50 | tab receiver hole |

### DESCRIPTION—Fig A and Fig B—PREFERRED EMBODIMENT

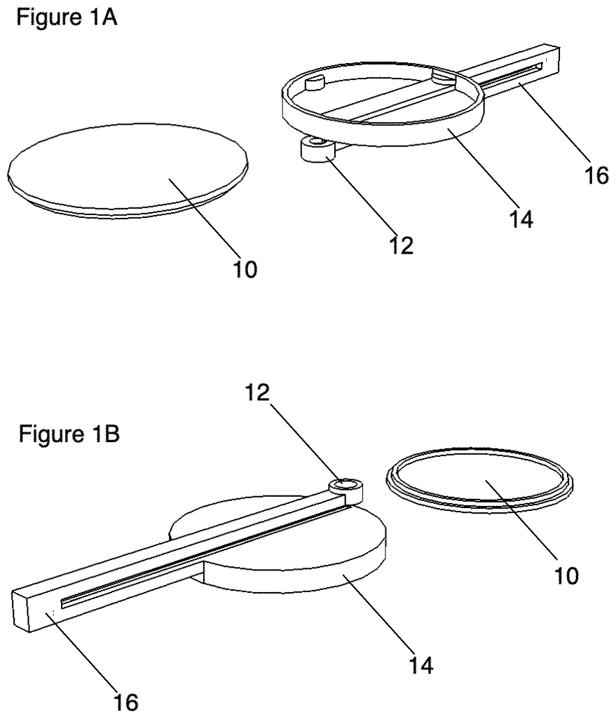

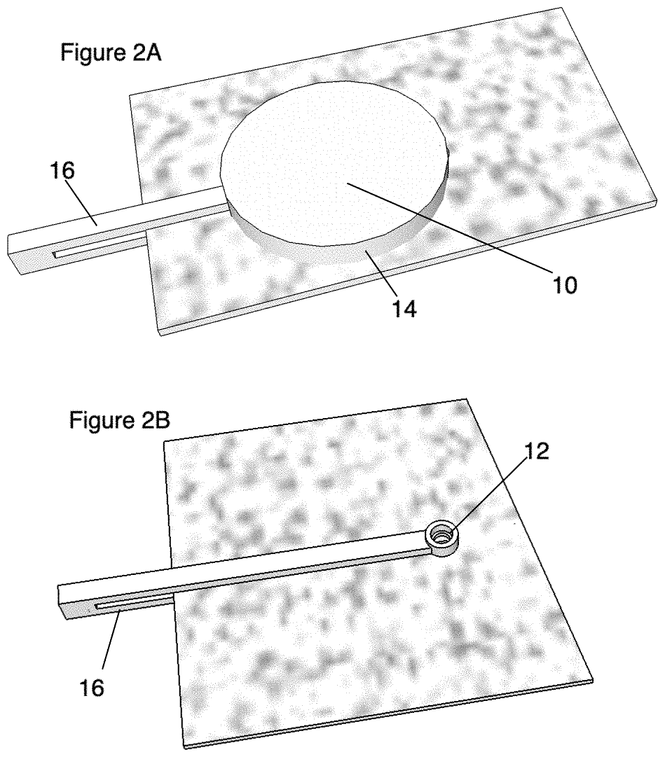

A preferred embodiment of the present invention is illustrated in FIG. 1A and 1B. The media platform consists of a microphone 12, case 14, case top 10 and support means 16 to join the combination thereof which can be clasped about fabric or materials (FIG. 2A, 2B). It can also be clasped about non-fabric materials. In the preferred embodiment, the case and support means is a non-brittle plastic such as is common to injection molding or 3D printing filaments such as PLA. However, the case can consist of any other material that can be expanded slightly without fracturing including soft woods, bamboo, rubber, vinyl, various plasticized materials, etc.

The case houses an electronic means to convert audio signals from the speech detection means 12 into various media, namely light emitting diodes of various wavelengths in the present iteration, with the top case 10 being of various levels of translucency. The current iteration uses printed circuit boards and surface mount devices including LEDs and transmitters, fitting neatly inside the case with little weight.

The top cases could also be made of any other translucent material, often plastics rather than glass given the proximity to the face. Thus the resultant media platform illuminates through the case top in relationship to the underlying speech. A graphic is applied to the case top 10 through means such as a sticker or printing means to create a backlit effect that accentuates the speaker's speech, said sticker having light permeable qualities as well.

The support means 16 joins the case with the microphone 12 to tolerances consistent with creating a clasping action, by which the whole may be attached to fabric or other material. Here it is contemplated that those materials might be worn about the face. The resultant clasp acts to position the microphone about the user's mouth while the top case faces outward in order to project the media on the anterior plane of the material.

The support means here is molded to the case, though fasteners or adhesives may also serve this purpose. The support means here may also contain a groove 42 to house wires to relay the sound signal to the case, though the groove 42 would not be required should any wireless means be implemented or the wires be run within the support means.

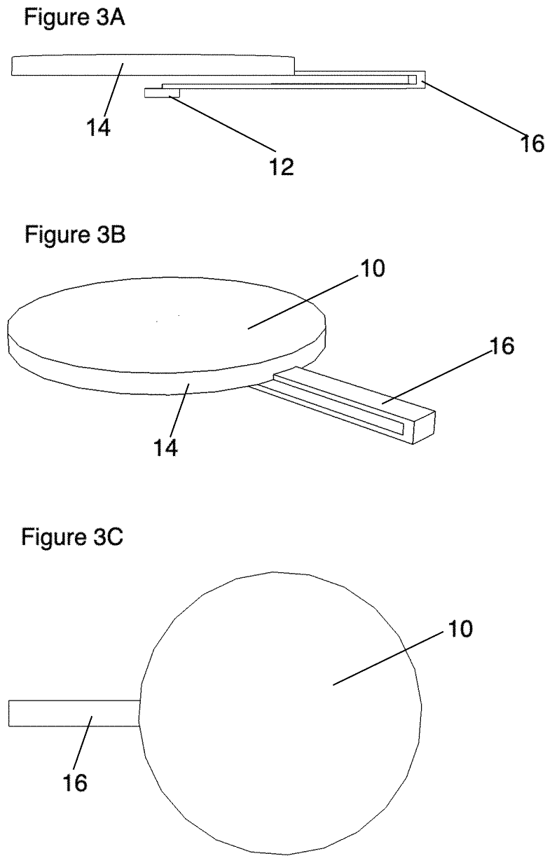

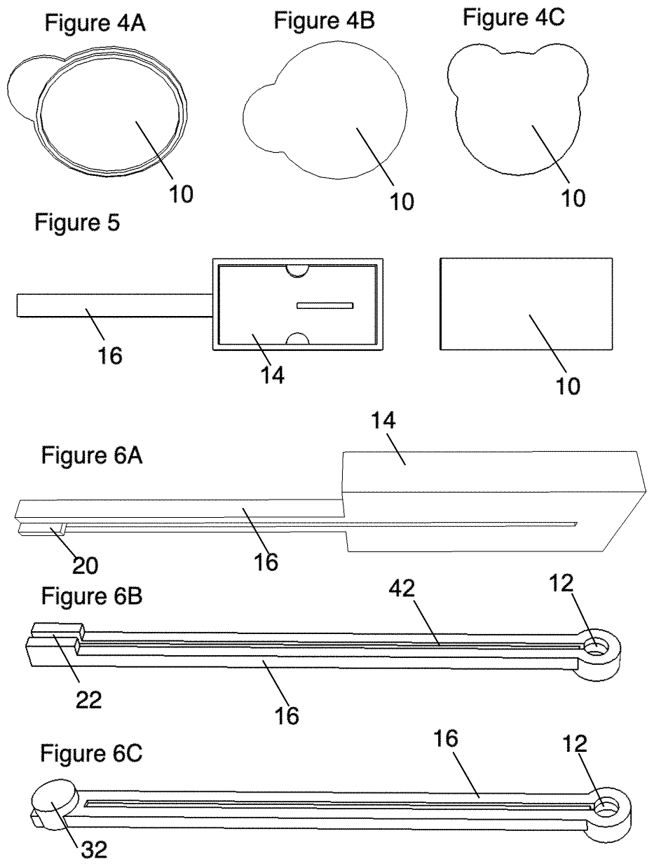

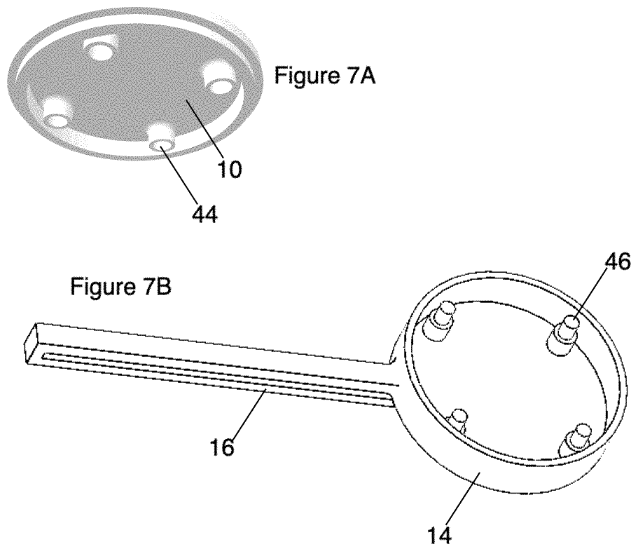

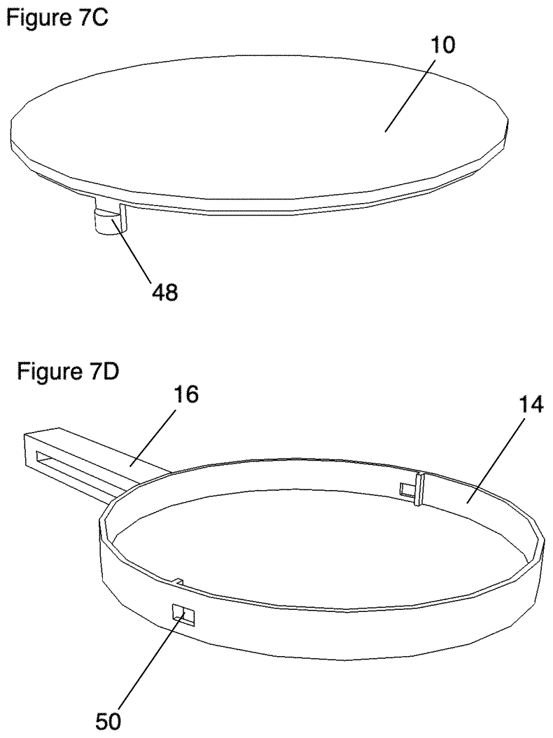

The case top 10 is attached to the case 14 using screws 44, 46 or could be attached using tabs 48, 50 as well as other means (FIG. 7A to 7D) that also ideally allow for changeable case top shapes (FIG. 3A to 3C) for multiple permutations as well as efficient replacement of power source, if warranted.

### Additional Embodiments

Additional embodiments are shown in FIGS. 3A to 3C where the case tops are shaped as well as in FIG. 5 where the case can be shaped as well as into any shape. The means of attaching case tops is variable as well (FIG. 7A to 7D).

### Alternative Embodiments

There are various possibilities with regard to the elements of media that may be housed on the media platform, including UV lights or ultrasonic emissions to promote health about the oral cavity, or many other components that may be surface mounted or attached otherwise. The media platform could also be adjusted for non-human use, to fit a dog's collar for example by resizing the support arm and the resulting clasp specifications. (As in FIG. 3A, perhaps.)

### Advantages

From the description above, a number of advantages of my media platform become evident:
(a) The number of permutations in color and shapes with changeable case tops that increase consumer value.
(b) The availability of several case top to case joining methods to tailor to manufacturing options available, including molding, adhesives and fasteners.
(c) Augmenting speech about the face with light and graphics enhances communication and signaling for those whose face and thus communication may be obfuscated by a facial covering, especially school children.
(d) A novel means to make wearing a mask amusing and fun.
(e) To impact speech with additional means of communication so that the wearer need not shout from behind a mask to promote an issue, thus enabling freedom of speech with a reduction in spittle.
(f) By coordinating a media response to speech and resulting spittle, promoting health about the oral cavity.
(g) Multiple color and shape choices enhances consumer choice.
(h) Economical joining of the support arm to case by various methods available such as fasteners, molding or adhesive give producers a myriad of options.
(i) An available on/off switch to promote battery life and reduce waste.

### Operation—FIG. 2A and 2B

The manner of using the media platform to enhance speech while wearing a mask resembles applying any simple clasp to fabric or material, such as a paper clip to paper. Firstly, the fabric, say, is inserted between the case 14 and support arm 16, the microphone 12 end of the device creating the open end of the clip and the opposite end being closed. The fabric is slid along the length of the device until it nearly reaches the closed end of the support means which connects the microphone to the case.

A means of power is supplied so that the condenser microphone 12 passes a signal to the case 14 when speech is detected. The wearer positions the microphone about the mount on the interior side of the facial covering. FIG. 2B. In turn, the media platform is positioned about the face on the opposite side of the fabric.

To activate the media platform so that light is emitted and a graphic illuminated, the user needs only to speak. This will cause an illumination on the exterior of the facial covering that augments verbal signaling. Verbal communication is still significantly visual, thus the enhancement aids communication.

To change the case top, two tabs 48 are depressed using the fingers and the cover can be removed from the case 14. A new coverage can be installed in the reverse.

The device can be removed from the material by sliding the material away from the closed support end of the device. The power may be disconnected via a switch.

### Conclusion, Ramifications and Scope of Invention

Thus the reader will see that the media platform of the invention provides an effective, fun and economical means to augment the speech of a person wearing a face covering while offering a host of customizable case tops that add value and appeal for users of all ages. The medial platform also serves to enhance and foment speech without an increase in viral vectors found in spittle. Furthermore, the media platform has the additional advantages in that
it permits a high number of different colorings, sizes and shapes;
it allows manufacture of a near limitless number of surface mounted devices to the printed circuit board to be actuated about the face by speech while wearing a face covering; and
it provides a means to position media about the face on a face covering without requiring penetration of the covering material.

While my above description contains many specificities, these should not be construed as limitations on the scope of the invention, but rather as an exemplification of one preferred embodiment thereof. For example, the device could be fitted to a dog's collar to signal the location of a bark, the medial platform containing surface mount LEDs or even a GPS pinging device. Ultrasonic wavelength generating devices could be placed on the platform also, retarding unhealthy spittle vectors to promote health while wearing a mask.

Thus the scope of the invention should be determined by the appended claims and their legal equivalents, rather than by the examples given.

I claim:

1. An electronic device comprising:
a. a speech detection device,
b. a case,
c. an electronic means housed in said case, and
d. a support means joining said device and case to form a clasp
whereby speech is converted to media signals positioned about the face.

2. The device of claim 1 whereby speech is converted to media signals positioned about the face on a face covering without penetration of said covering.

3. The device of claim 1 wherein said speech detection device is a condenser microphone.

4. The device of claim 3 wherein said electronic means is a circuit containing a device selected from the group consisting of LEDs and transmitters.

5. The device of claim 4 whereby energy is emitted about the face.

6. The device of claim 4 whereby lights flash when speech is detected.

5. The device of claim 5 whereby ultrasound is emitted.

8. A method for positioning a voice media platform about the face, comprising the steps of:
a. attaching a speech recognition device to one end of a support means,
b. fashioning the support means together with a case at its opposite end,
c. folding said support means to form a clasp,
d. placing said clasp about a face covering,
e. providing an electronic means to convert speech signals into media, and
f. positioning said media about the face whereby speech is supplemented with media.

9. The method of claim 8 wherein said speech recognition device is a condenser microphone.

10. The device of claim 1 further including:
a. a condenser microphone,
b. a plastic case,
c. a circuit containing a device selected from the group of consisting of LEDs and transmitters housed inside said case,
d. a case cover,
e. a support means joining said case and microphone to form a clasp and
whereby speech is converted to media signals positioned about the face.

11. The device of claim 10 whereby energy is emitted when speech is detected.

12. The method of claim 8 whereby light is emitted when speech is detected.

13. The method of claim 12 whereby energy is emitted when speech is detected.

14. The device of claim 10 whereby speech is converted to media signals positioned on a face covering without penetration of said covering.

15. In combination:
a. a condenser microphone,
b. a plastic case,
c. a circuit containing a device selected from the group of consisting of LEDs and transmitters housed inside said case,
d. a case cover,
e. a support means joining said case and microphone to form a clasp and
whereby speech is converted to media signals positioned about the face.

16. The device of claim 4 whereby speech is converted to media signal positioned about the face on a face covering without penetration of said covering.

17. The combination of claim 15 wherein case cover is transparent.

18. The combination of claim 15 wherein case cover is soundwave permeable.

19. The device of claim 10 whereby speech is converted to media signals positioned about a material without penetration of said material.

20. The device of claim 4 whereby speech is converted to media signals positioned about a material without penetration of said material.
